(19) United States
(12) Patent Application Publication
(10) Pub. No.: US 2015/0129056 A1
(43) Pub. Date: May 14, 2015

(54) LOW PRESSURE SEAL FOR VALVE

(71) Applicant: Meir Shoval, Kfar Charuv (IL)

(72) Inventor: Meir Shoval, Kfar Charuv (IL)

(21) Appl. No.: 14/078,593

(22) Filed: Nov. 13, 2013

(51) Int. Cl. F16K 1/46; F16K 15/02

(52) U.S. Cl. CPC F16K 1/465; F16K 15/02
USPC 137/511

(57) ABSTRACT

A valve assembly includes a valve with an annular seal installed therein. The annular seal includes an inner sealing member formed with an annular channel with an open end that faces downwards. The inner sealing member and the annular channel define an annular flap with an outer wall, which is an inner wall of the annular channel. A floating member is arranged to float up and rise with a water level present in a portion of the valve and press against the annular seal.

### FIELD OF THE INVENTION

The present invention relates to valves and seals for valves, and particularly to a low pressure valve with a hydraulic seal against which a floating member rises to ensure proper sealing even at low pressure heads, such as for anti-flood valves.

### BACKGROUND OF THE INVENTION

Anti-flood valves are well known in the art for preventing backwater surges in sewers, drain pipes and the like. They have different constructions and modes of operation. One prior art anti-flood valve is shown in FIG. 1.

The anti-flood valve has a floating ball 1 that floats in water in a pipe housing 2. Nominally, with normal water levels, the floating ball 1 floats on the water level (lower ball). In the event of a flood or other source of backwater, the water level rises and the floating ball 1 rises with the water level until it seats and seals against a seal 3 (upper ball). This prevents backwater from rising through the top of the pipe and thus prevents flooding above the pipe.

A problem with such floating ball anti-flood valves is the contact between the ball and the seal is not very good if the water head is low, such as when the water level rises slowly and not suddenly. The poor contact between ball and seal can lead to water escaping through between the ball and seal.

### SUMMARY OF THE INVENTION

The present invention seeks to provide an improved valve with a hydraulic seal against which a floating member rises to ensure proper sealing even at low pressure heads, as is described more in detail further below. The floating member may be a floating ball, but the invention is not limited to a spherical member and may be carried out with other shapes as well (e.g., half-ball, elliptical, prismatic and many others).

There is provided in accordance with an embodiment of the present invention a valve assembly including a valve with an annular seal installed therein, the annular seal including an inner sealing member formed with an annular channel with an open end that faces downwards, the inner sealing member and the annular channel defining an annular flap with an outer wall, which is an inner wall of the annular channel, and a floating member arranged to float up and rise with a water level present in a portion of the valve and press against the annular seal.

In accordance with an embodiment of the present invention, when after the floating member has risen to press against the annular flap, water is able to rise and flow around an outside contour of the floating member and enter the annular channel to apply hydraulic pressure directed radially inwards against the inner wall of the annular channel to press the annular flap against the floating member to increase sealing contact between the floating member and the annular seal.

### BRIEF DESCRIPTION OF THE DRAWINGS

The present invention will be understood and appreciated more fully from the following detailed description, taken in conjunction with the drawings in which:

FIG. 1 is a simplified illustration of a prior art anti-flood valve with floating ball;

FIG. 2 is a simplified illustration of a hydraulic seal for use with a valve with floating member, in accordance with an embodiment of the present invention;

FIG. 3 is a cross-sectional view of the seal of FIG. 2, taken along lines A-A in FIG. 2; and

FIG. 4 is a close-up view of a portion of FIG. 3, installed in an anti-flood valve, with a floating member pressing against the seal, and wherein hydraulic pressure in the hydraulic seal presses the seal against the floating member, in accordance with an embodiment of the present invention.

### DETAILED DESCRIPTION

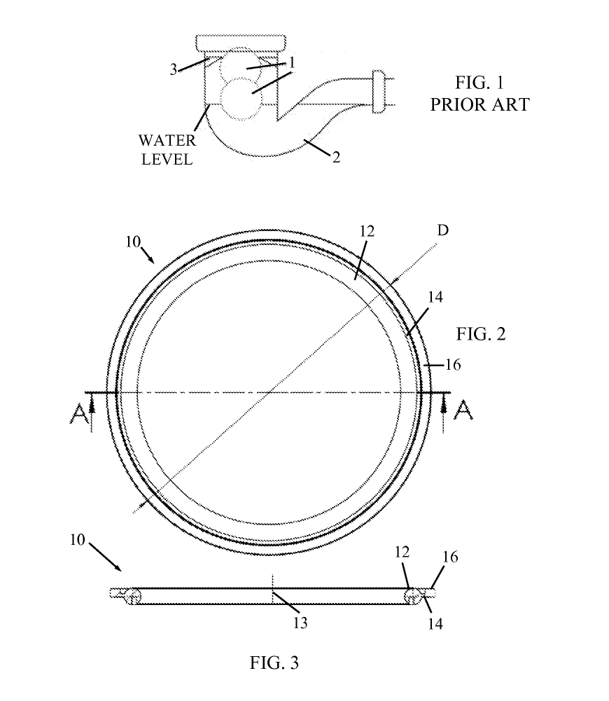

Reference is now made to FIGS. 2-3, which illustrate a hydraulic seal 10 for use with a valve with a floating member (such as, but not limited to, anti-flood valves), constructed and operative in accordance with a non-limiting embodiment of the present invention.

The seal 10 is an annular (meaning ring-shaped) seal, which made be made of any suitable elastomeric material, such as but not limited to, natural rubber or synthetic rubber, such as EPDM (ethylene propylene diene monomer), butyl, styrene butadiene or neoprene, or a thermoplastic elastomer (e.g., polyurethane or olefin). Seal 10 may be manufactured in a wide variety of outer diameters (D) and inner diameters.

In the illustrated embodiment, the seal 10 has an inner sealing member 12 which is circular in cross-section, but which may be elliptical, trapezoidal, rectangular, square, U-shaped or other shapes as well. (“Inner” refers to more inner in the radial direction with respect to the center 13 of the ring-shaped seal 10.) An annular rib member 14 extends radially outwards from inner sealing member 12. An outer mounting member 16 extends radially outwards from annular rib member 14. The outer mounting member 16 is shown as rectangular in cross-section, but may of any arbitrary shape as well. The rib member 14 and outer mounting member 16 are optional and in some applications (depending on the mounting conditions) the invention can be carried just with inner sealing member 12.

The inner sealing member 12 is formed with an annular channel 18 which has an open end that faces downwards, that is, towards the water line below the seal. The annular channel 18 is shown as rectangular in cross-section, but may of any arbitrary shape as well. For example, annular channel 18 may have straight sides or sloping sides.

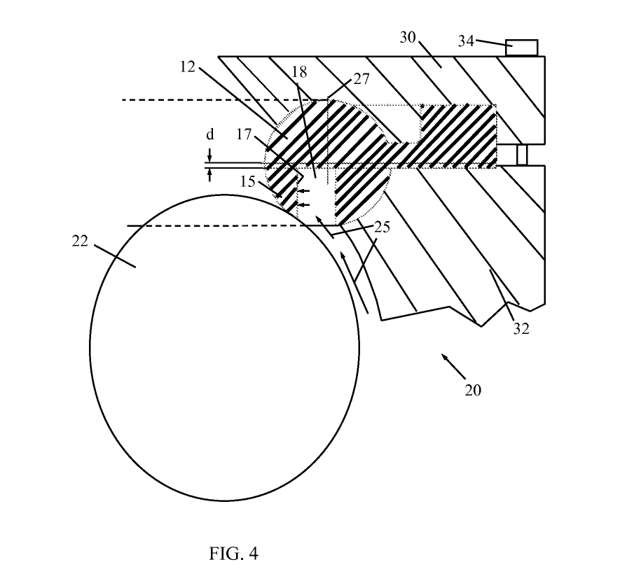

Reference is now made to FIG. 4, which illustrates seal 10 installed in an anti-flood valve 20, in accordance with an embodiment of the present invention. In FIG. 4, it is seen that inner sealing member 12 and annular channel 18 define an annular flap 15 with an outer wall 17, which is also referred to as the inner wall 17 of annular channel 18. As seen in FIG. 4, the annular channel 18 may be off-center with respect to a centerline 27 of inner sealing member 12 and may be radially offset (e.g., more radially inwards) by a distance d from the center of inner sealing member 12.

Without limitation, the outer mounting member 16 is shown mounted between an upper valve member 30 and a lower valve member 32 of a valve housing, which are tightened together by a mechanical fastener 34. Other installations and other kinds of valve housings are possible as well. The invention is not only applicable to anti-flood valves, but also any other valve applications requiring sealing at very low pressures.

Valve 20 includes a floating member 22 which floats up and rises with the water level 24. FIG. 4 shows floating member 22 (not shown to scale) after it has risen to the point where it presses against the annular flap 15 of the inner sealing member 12 of seal 10. Any water that continues to rise will flow around the outside contour of member 22 and enter annular channel 18, as indicated by arrows 25. The water that has entered annular channel 18 applies hydraulic pressure directed radially inwards against the inner wall 17 of annular channel 18. This hydraulic pressure presses the flap 15 against member 22 to increase the sealing contact between member 22 and seal 10, even at low pressure heads.

The scope of the present invention includes both combinations and subcombinations of the features described hereinabove as well as modifications and variations thereof which would occur to a person of skill in the art upon reading the foregoing description and which are not in the prior art.

What is claimed is:

1. A valve assembly comprising:
a valve with an annular seal installed therein, said annular seal comprising an inner sealing member formed with an annular channel with an open end that faces downwards, said inner sealing member and said annular channel defining an annular flap with an outer wall, which is an inner wall of said annular channel; and
a floating member arranged to float up and rise with a water level present in a portion of said valve and press against said annular seal.

2. The valve assembly according to claim 1, wherein when after said floating member has risen to press against said annular flap, water is able to rise and flow around an outside contour of said floating member and enter said annular channel to apply hydraulic pressure directed radially inwards against said inner wall of said annular channel to press said annular flap against said floating member to increase sealing contact between said floating member and said annular seal.

3. The valve assembly according to claim 1, wherein said inner sealing member is circular in cross-section.

4. The valve assembly according to claim 1, wherein an annular rib member extends radially outwards from said inner sealing member.

5. The valve assembly according to claim 4, wherein an outer mounting member extends radially outwards from said annular rib member.

6. The valve assembly according to claim 1, wherein said annular channel is off-center with respect to a centerline of said inner sealing member.

7. The valve assembly according to claim 1, wherein said annular channel is radially offset from a center of said inner sealing member.
